(19) United States
(12) Patent Application Publication
(10) Pub. No.: US 2022/0309641 A1
(43) Pub. Date: Sep. 29, 2022

(54) SYSTEM AND METHOD FOR ANALYZING IMAGE

(71) Applicant: TECO Electric & Machinery Co., Ltd., TAIPEI CITY (TW)

(72) Inventors: Chia-Jen LIN, TAIPEI CITY (TW); Feng-Chieh LIN, TAIPEI CITY (TW); Chun-Chi LAI, TAIPEI CITY (TW); Chin-Sheng CHEN, TAIPEI CITY (TW)

(21) Appl. No.: 17/351,372

(22) Filed: Jun. 18, 2021

(30) Foreign Application Priority Data
Mar. 26, 2021 (TW) 110111030

(51) Int. Cl. G06T 7/00; H02H 7/08; G06T 7/30

(52) U.S. Cl. CPC G06T 7/0004; H02H 7/0822; G06T 7/30; G06T 2207/30108; G06T 2207/30268

(57) ABSTRACT

A system for analyzing image includes a data-acquiring module, a waveform-constructing module, a sampling module, a transforming module, and an analyzing module. The present system is utilized to retrieve normal data and real-time data, generate a normal waveform and a real-time waveform, sample normal sampling data from normal data and real-time sampling data from real-time data, transform first RGB values and second RGB values, and generate normal images and real-time images. The present system is utilized to detect whether a servo motor system is abnormal by analyzing real-time images with respect to normal images. In addition, a method of analyzing image is also provided.

This application claims the benefit of Taiwan Patent Application Serial No. 110111030, filed Mar. 26, 2021, the subject matter of which is incorporated herein by reference.

### BACKGROUND OF THE INVENTION

### (1) Field of the Invention

The invention relates to a system and a method, and more particularly to a system and method for analyzing image.

### (2) Description of the Prior Art

The motor, also known as an electric motor, is one of popular electrical devices that can convert electrical energy into kinetic energy for driving the other devices. The principle of the motor and that of a generator are roughly the same, and the main difference in between lies in the style of energy conversion.

Among various applications of motors, a servo motor drive system, generally including a servo motor and an actuator, is widely applied to elevators, cranes, oil pumps and so on. In particular, the oil pump used for exploring oil and gas is one of important exemplary examples of the servo motor system, no matter where the exploration is on land or at sea. On the other hand, under long-term operations, the actuator would inevitably meet problems such as capacitor degradation, component damages and invasion of foreign matters. Eventually, the associated servo motor drive system would go wrong to induce some kinds of abnormality in machinery safety or comfort to specific fields, such as elevators and cranes. Now, speaking back to the issue of the oil pump for exploring oil and gas, if the servo motor drive system is shut down due to any abnormality, then daily gross loss would be probably up to USD140,000. Obviously, reliability and real-time detection diagnosis of the servo motor drive system become increasingly important.

### SUMMARY OF THE INVENTION

In view that, after long-term operations of the conventional servo motor drive system, several problems would meet inevitably, such as actuator problems, abnormality in the servo motor drive system and some other derivative problems, accordingly it is an object of the present invention to provide a system and method for analyzing image to resolve at least one of the aforesaid problems in the art.

In accordance with the present invention, a system for analyzing image, applied to a servo motor drive system, includes a data-acquiring module, a waveform-constructing module, a sampling module, a transforming module and an analyzing module. The data-acquiring module is configured for receiving M normal operation data and M real-time operation data from the servo motor drive system. The waveform-constructing module is configured for receiving the M normal operation data and the M real-time operation data, and further for constructing a normal operation waveform and a real-time operation waveform. The sampling module is configured for evaluating the normal operation waveform and the real-time operation waveform to sample N normal-operation data sets and N real-time-operation data sets. Each of the N normal-operation data sets includes O normal-operation sampling data sampled from the M normal operation data, each of the N real-time-operation data sets includes O real-time-operation sampling data sampled from the M real-time operation data, N<M, and O<M. The transforming module is configured for receiving N×O normal-operation sampling data and N×O real-time-operation sampling data, then for converting each of the N×O normal-operation sampling data into a first RGB value through a color conversion, further for converting each of the N×O real-time-operation sampling data into a second RGB value through the color conversion, and thereby for generating a normal operation image and a real-time operation image. The analyzing module is configured for utilizing the normal operation image to analyze the real-time operation image, and for generating an abnormal signal upon when a difference between the second RGB value and the corresponding first RGB value fulfills an abnormal condition. The color conversion is to multiply each of the normal-operation sampling data and each of the real-time-operation sampling data by 255, and then converts to form the first RGB value and the second RGB value.

In one embodiment of the present invention, the abnormal condition is to indicate that the first RGB value of the normal operation image is not equal to the second RGB value of the corresponding real-time operation image.

In one embodiment of the present invention, the abnormal condition is to indicate that the second RGB value of the real-time operation image is different to the first RGB value of the corresponding normal operation image.

In one embodiment of the present invention, the data-acquiring module includes an analog-to-digital conversion unit configured for converting data formats of the N×O normal operation data and the N×O real-time operation data from analog formats into digital formats.

In one embodiment of the present invention, the data-acquiring module further includes a normalization unit electrically connected with the analog-to-digital conversion unit and configured for performing data normalization upon the N×O normal operation data and the N×O real-time operation data.

In one embodiment of the present invention, the data-acquiring module further includes a standardization unit electrically connected with the analog-to-digital conversion unit and configured for performing standardization upon the N×O normal operation data and the N×O real-time operation data.

In one embodiment of the present invention, the sampling module includes a window-sampling unit configured for moving along the normal operation waveform and the real-time operation waveform so as to sample the N×O normal operation data and the N×O real-time operation data.

In one embodiment of the present invention, the sampling module further includes a window-setting unit electrically connected with the window-sampling unit for setting a sampling width of the window.

In one embodiment of the present invention, the system for analyzing image further includes a display module electrically connected with the transforming module and used for receiving and displaying the normal operation image and the real-time operation image.

In one embodiment of the present invention, the system for analyzing image further includes an alert module electrically connected with the analyzing module and used for generating an alert message upon when the abnormal signal is received.

In accordance with the present invention, a method for analyzing image includes: a step of utilizing the data-acquiring module to receive the M normal operation data and the M real-time operation data; a step of utilizing the waveform-constructing module to receive the M normal operation data and the M real-time operation data to further construct the normal operation waveform and the real-time operation waveform; a step of utilizing the sampling module to evaluate the normal operation waveform and the real-time operation waveform to further sample the O normal-operation sampling data and the O real-time-operation sampling data; a step of utilizing the transforming module to receive the O normal-operation sampling data and the O real-time-operation sampling data, to obtain the first RGB value and the second RGB value, through conversion, and to generate the normal operation image and the real-time operation image; and, a step of utilizing the analyzing module to generate the abnormal signal upon when the difference between the second RGB value and the corresponding first RGB value is determined to fulfill the abnormal condition.

In one embodiment of the present invention, the method for analyzing image further includes a step of utilizing a display module to display the normal operation image and the real-time operation image.

As stated, in the system and method for analyzing image provided by the present invention, the data-acquiring module, the waveform-constructing module, the sampling module, the transforming module and the analyzing module are included. In comparison to the prior art, the present invention can utilize the normal operation image and the real-time operation image to analyze in a real-time manner if any of the differences between the second RGB values and the corresponding first RGB values fulfills the abnormal condition, to further realize if the servo motor drive system is in the abnormal state, and thus to perform maintenance, repair and treatment in time to remove the abnormal state. In addition, the present invention can further utilize the display module to display the normal operation image and the real-time operation image, so that the instant state of the servo motor drive system can be determined immediately.

All these objects are achieved by the system and method for analyzing image described below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The present invention will now be specified with reference to its preferred embodiment illustrated in the drawings, in which:

FIG. 1 is a schematic block view of a preferred embodiment of the system for analyzing image in accordance with the present invention;

FIG. 2 demonstrates schematically a normal operation waveform provided by the waveform-constructing module of FIG. 1;

FIG. 3 demonstrates schematically another normal operation waveform provided by the waveform-constructing module of FIG. 1;

FIG. 4 demonstrates schematically sampling of the sampling module upon the normal operation waveform of FIG. 3;

FIG. 5A and FIG. 5B illustrate schematically normal operation images in accordance with the present invention;

FIG. 6 demonstrates schematically a real-time operation waveform provided by the waveform-constructing module of FIG. 1;

FIG. 7 demonstrates schematically another real-time operation waveform provided by the waveform-constructing module of FIG. 1;

FIG. 8 demonstrates schematically sampling of the sampling module upon the real-time operation waveform of FIG. 7;

FIG. 9A and FIG. 9B illustrate schematically real-time operation images in accordance with the present invention; and

FIG. 10 is a schematic flowchart of a preferred embodiment of the method for analyzing image in accordance with the present invention.

### DESCRIPTION OF THE PREFERRED EMBODIMENT

The invention disclosed herein is directed to a system and method for analyzing image. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

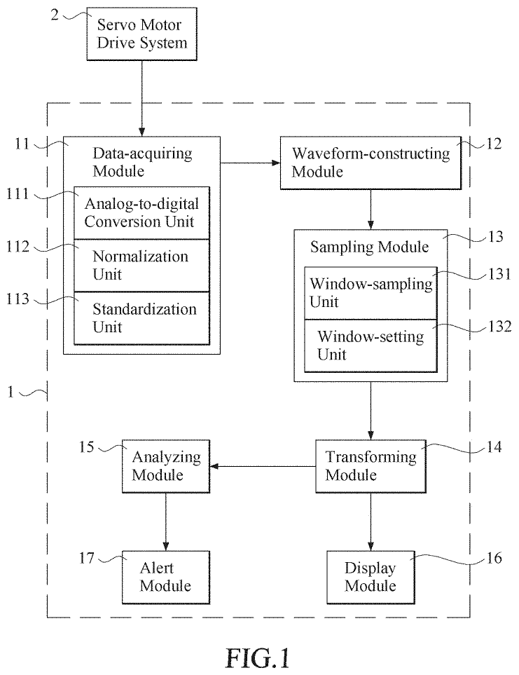

Referring now to FIG. 1, a schematic block view of a preferred embodiment of the system for analyzing image in accordance with the present invention is shown. In this embodiment, the system for analyzing image 1, applied to a servo motor drive system 2, includes a data-acquiring module 11, a waveform-constructing module 12, a sampling module 13, a transforming module 14 and an analyzing module 15. In addition, the system for analyzing image 1 further includes a display module 16 and an alert module 17. Generally, the servo motor drive system 2 includes a servo motor and an actuator, in which the actuator usually adopts a frequency converter. This frequency converter is a prior art, and thus detail thereabout is omitted herein.

The data-acquiring module 11, used for receiving M normal operation data and M real-time operation data captured from the servo motor drive system 2, includes an analog-to-digital conversion unit 111, a normalization unit 112 and a standardization unit 113.

The analog-to-digital conversion unit 111 is used to transform data formats of the received normal operation data and real-time operation data from original analog formats into corresponding digital formats, so that following operations can be much easier.

The normalization unit 112 is used for performing data normalization upon the normal operation data and the real-time operation data, so that following operations can be much easier. In this embodiment, the data normalization is one of popular data-processing means that modulates data into corresponding values between 0 and 1 without varying the associated distribution pattern of the data.

The standardization unit 113 is used for performing standardization upon the normal operation data and the real-time operation data, so that following operations can be much easier. The standardization is one of popular statistic means that applies relevant formula to modulate data into corresponding values between 0 and 1 without varying the associated distribution pattern of the data.

It shall be explained that the standardization unit 113 and the normalization unit 112 follow almost similar steps for processing data. In this embodiment, though these two units are both included, yet such an example is only for concise explanation. Practically, according to the present invention, the system for analyzing image can simply include anyone of these two units 112, 113.

The waveform-constructing module 12, electrically connected with the data-acquiring module 11, is used for receiving M normal operation data and M real-time operation data, and thereby for constructing correspondingly a normal operation waveform and a real-time operation waveform.

The sampling module 13, electrically connected with the waveform-constructing module 12, is used for evaluating the normal operation waveform and the real-time operation waveform to sample N normal-operation data sets and N real-time-operation data sets, respectively. Each of the N normal-operation data sets includes O normal-operation sampling data sampled from the M normal operation data, and each of the N real-time-operation data sets includes O real-time-operation sampling data sampled from the M real-time operation data, in which N<M and O<M. In this embodiment, the sampling module 13 further includes a window-sampling unit 131 and a window-setting unit 132.

The transforming module 14, electrically connected with the sampling module 13, is used for receiving N×(the O normal-operation sampling data) and N×(the O real-time-operation sampling data), then, according to a color conversion, for converting each of the normal-operation sampling data into a corresponding first RGB value and each of the real-time-operation sampling data into a corresponding second RGB value, and thereupon for generating correspondingly a normal operation image and a real-time operation image, respectively.

The analyzing module 15, electrically connected with the transforming module 14, can utilize the normal operation image to analyze the real-time operation image so as to realize a difference between the second RGB value and the corresponding first RGB value. If the difference fulfills an abnormal condition, then the analyzing module 15 would generate an abnormal signal, accordingly.

In this embodiment, the color conversion is carried out by multiplying each of the normal-operation sampling data and each of the real-time-operation sampling data by a value 255 so as to form correspondingly the aforesaid first RGB value and the aforesaid second RGB value.

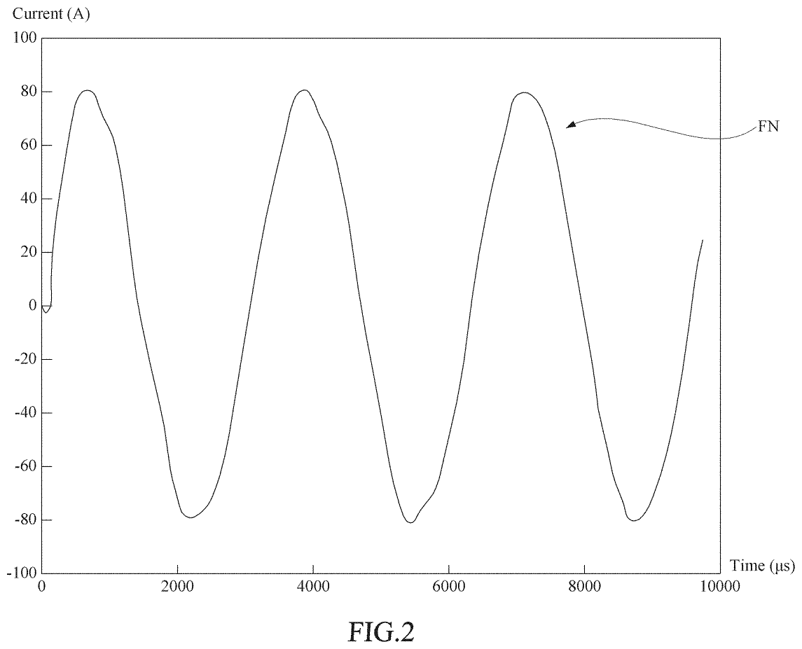

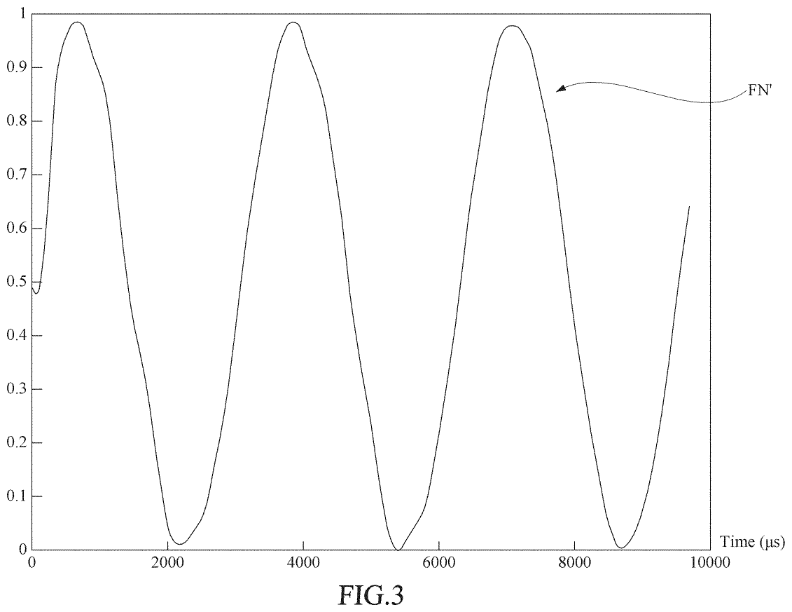

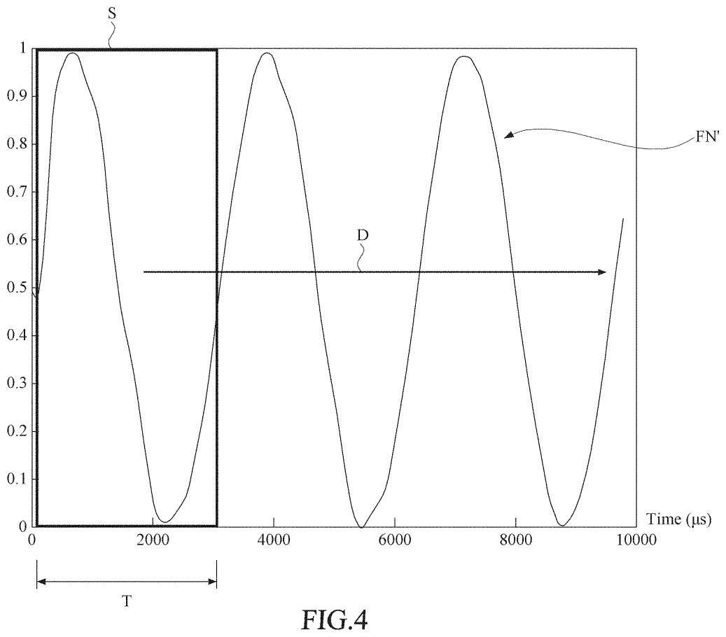

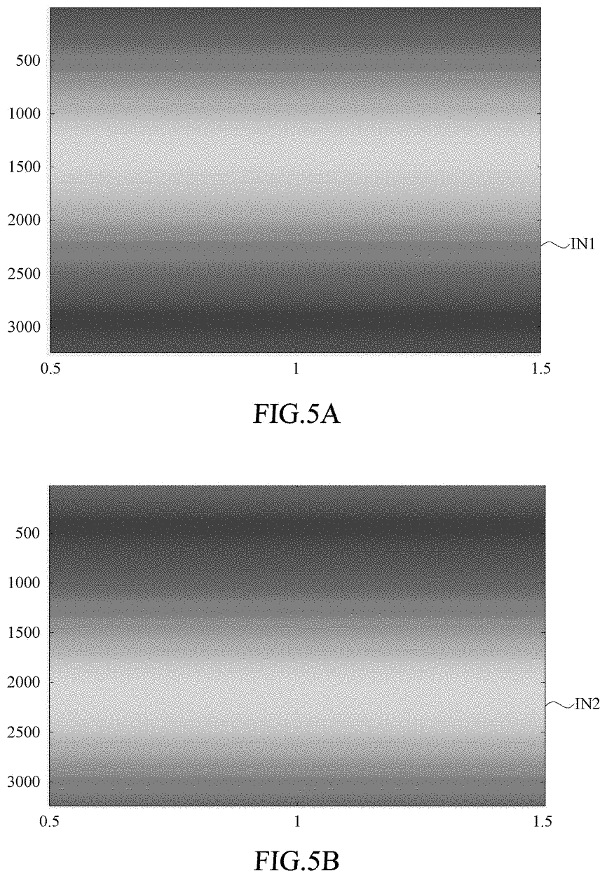

Then, refer to FIG. 1 through FIG. 5B; where FIG. 2 demonstrates schematically a normal operation waveform provided by the waveform-constructing module of FIG. 1, FIG. 3 demonstrates schematically another normal operation waveform provided by the waveform-constructing module of FIG. 1, FIG. 4 demonstrates schematically sampling of the sampling module upon the normal operation waveform of FIG. 3, and FIG. 5A and FIG. 5B illustrate schematically normal operation images in accordance with the present invention. As shown, the data-acquiring module 11 would receive the M normal operation data captured from the servo motor drive system 2. According to the present invention, the normal operation data can be voltages, currents, pulse width modulations or any the like. Particularly, in this embodiment, as shown in FIG. 2, the normal operation data is current data, but not limited thereto.

The waveform-constructing module 12 would evaluate the M normal operation data to construct the corresponding normal operation waveform. If the M normal operation data are not processed by data normalization or standardization, then the waveform-constructing module 12 would construct a normal operation waveform FN as shown in FIG. 2. Preferably, if the M normal operation data are processed to generate data between o and 1 by the data normalization or standardization, then the waveform-constructing module 12 would construct another normal operation waveform FN′ as shown in FIG. 3.

Then, the sampling module 13 would introduce a window S onto the normal operation waveform FN′, and move the window S there-along in a sampling direction D so as to sample out the normal-operation sampling data. It shall be explained that the window S can obtain a normal-operation data set in each sampling, and each the normal-operation data set would include a plurality of the normal-operation sampling data sampled from the M normal operation data. The window-setting unit 132 is configured for manually setting a sampling width T for the window S. Practically, the sampling width T would be set to one, a half or a quarter of the wave period.

Generally speaking, for sampling continuity, the total number of the normal-operation sampling data would be greater than that of the normal operation data. Mathematically, for example, the normal operation data can form a (9728×1) vector (i.e., M=9278), while the normal-operation sampling data can form a (3243×1298) matrix (i.e., N=1298, and O=3243). Please note that, in this embodiment, M, the raw data, is the number of the normal or real-time operation data, O is the number of the normal-operation or real-time-operation sampling data sampled from the M raw normal or real-time operation data, N is the number of the normal-operation or real-time-operation data sets, and each of the N sets includes O normal-operation or real-time-operation sampling data. In other words, according to this embodiment, the N data sets are formed by execute N times of sampling upon the M raw data, and each of the N sampling is to fetch a number N data from the M raw data. Definitely, each of the M raw data would be fetched repeatedly to some extent. As such, the (3243×1298) matrix (i.e., N=1298, and O=3243) can be formed from the (9728×1) vector (i.e., M=9278).

The transforming module 14 would apply the color conversion to convert each of the normal-operation sampling data of each of the normal-operation data sets into the corresponding first RGB value, and use all the first RGB values to construct the normal operation image. In this embodiment, each of the normal-operation data sets would form a corresponding normal operation image. As shown, the transforming module 14 would use one of the normal-operation data sets to construct a normal operation image IN1, and another one of the normal-operation data sets to construct another normal operation image IN2.

Practically, the color conversion can be simply performed by using the “program designer/programmer” interface of the small abacus in the Microsoft system for conversion. Thus, the normal-operation sampling data can be multiplied by 255 to form corresponding color codes, and further to obtain, by conversion, the corresponding first RGB values. In the art, the color conversion is also called as the image color digitization, which is used to convert the value into the corresponding RGB value so as to present the color corresponding to the RGB value.

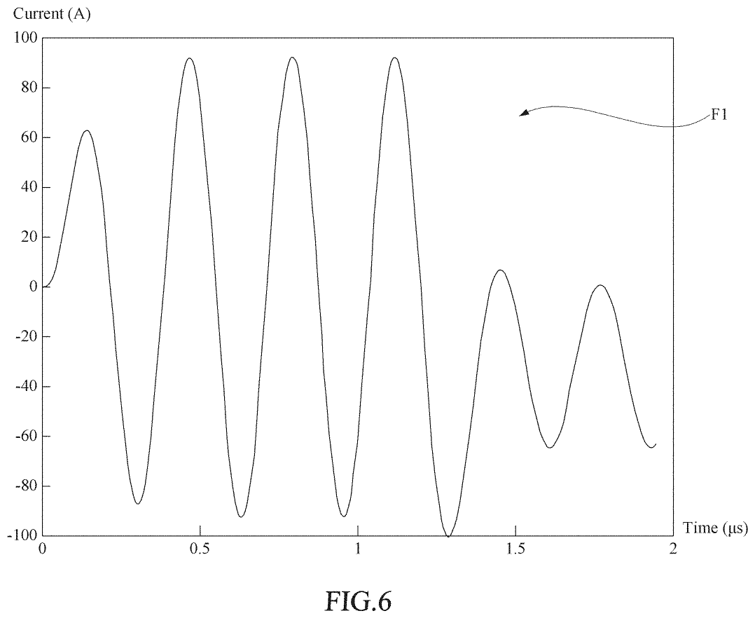

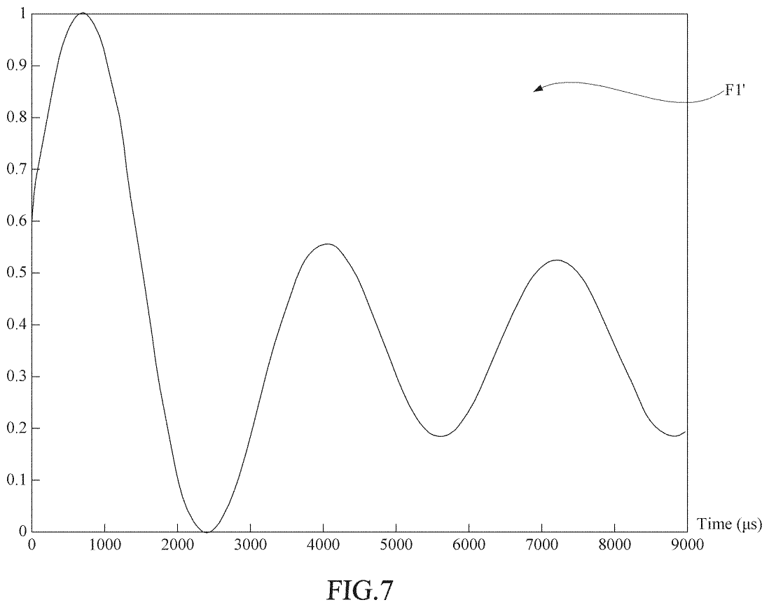

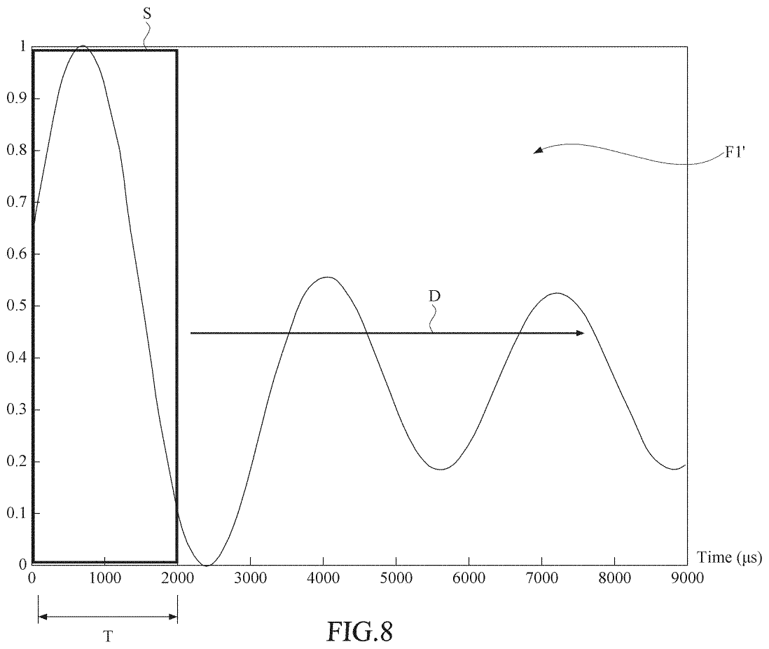

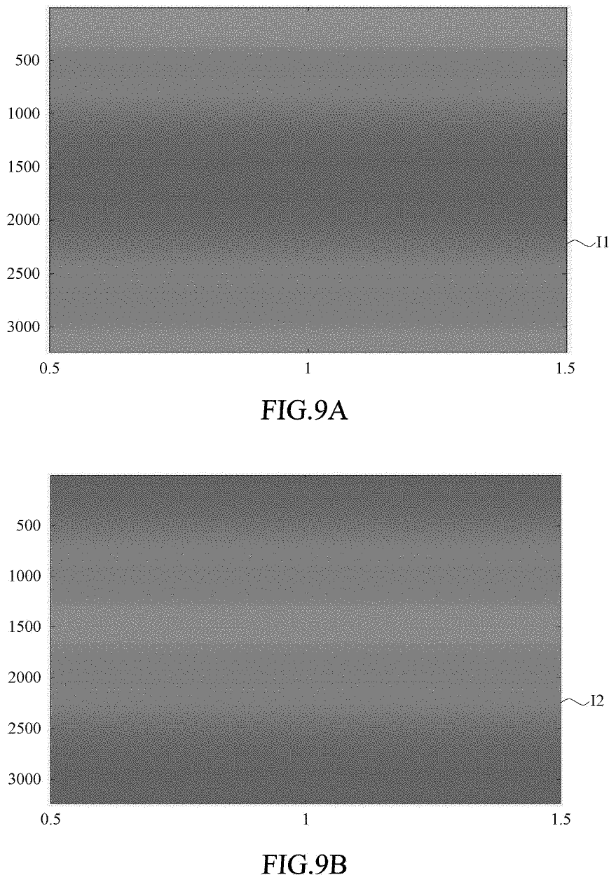

Then, refer to FIG. 1, and FIG. 6 through FIG. 9B together; where FIG. 6 demonstrates schematically a real-time operation waveform provided by the waveform-constructing module of FIG. 1, FIG. 7 demonstrates schematically another real-time operation waveform provided by the waveform-constructing module of FIG. 1, FIG. 8 demonstrates schematically sampling of the sampling module upon the real-time operation waveform of FIG. 7, and FIG. 9A and FIG. 9B illustrate schematically real-time operation images in accordance with the present invention. As shown, the data-acquiring module 11 would received M real-time operation data captured from the servo motor drive system 2.

The waveform-constructing module 12 would evaluate the M real-time operation data to construct the corresponding real-time operation waveform. If the M real-time operation data are not processed by data normalization or standardization, then the waveform-constructing module 12 would construct a real-time operation waveform F1 as shown in FIG. 6. Preferably, if the M real-time operation data are processed to generate data between o and 1 by the data normalization or standardization, then the waveform-constructing module 12 would construct another real-time operation waveform F1′ as shown in FIG. 7. It shall be explained that FIG. 7 of this embodiment demonstrates only the abnormal real-time operation waveform F1′.

Then, the sampling module 13 would introduce the window S onto the real-time operation waveform F1′, and move the window S there-along in the sampling direction D so as to sample out the real-time-operation sampling data. It shall be explained that the window S can obtain one real-time-operation data set in each sampling, and each of the real-time-operation data sets would include a plurality of the real-time-operation sampling data sampled from the M real-time operation data. The window-setting unit 132 is configured for manually setting a sampling width T for the window S.

The transforming module 14 would apply the color conversion to convert each of the real-time-operation sampling data in each of the real-time-operation data sets into the corresponding second RGB value, and use all the second RGB values to construct the real-time operation image. In this embodiment, each of the real-time-operation data set would form a corresponding real-time operation image. As shown, the transforming module 14 would use one of the real-time-operation data sets to construct a real-time operation image I1, and another one of the real-time-operation data sets to construct another real-time operation image I2.

The display module 16 would display the normal operation images (i.e., the normal operation images IN1, IN2 shown in FIG. 5A and FIG. 5B, respectively) and the real-time operation images (i.e., the real-time operation images I1, I2 shown in FIG. 9A and FIG. 9B, respectively) for user review. By comparing FIG. 5A, FIG. 5B, FIG. 9A and FIG. 9B, the real-time operation images I1, I2 in FIG. 9A and FIG. 9B, respectively, demonstrate no significant yellow color. Thus, it can be understood that, at this instance, the servo motor drive system 2 might be in an abnormal state.

The analyzing module 15 may also study the normal operation image (for example, the normal operation image IN1 or IN2 shown in FIG. 5A or FIG. 5B, respectively) to realize the corresponding real-time operation image (for example, the real-time operation images I1, I2 shown in FIG. 9A and FIG. 9B, respectively). When the analyzing module 15 determines that the difference between the second RGB value and the corresponding first RGB value fulfills the abnormal condition, then an abnormal signal would be generated. For example, the analyzing module 15 can compare each of the second RGB values to the corresponding first RGB value. As the number of the differences between the second RGB values and the corresponding first RGB values are accumulated to reach a threshold value, the analyzing module 15 would determine that the instant state fulfills the abnormal condition. In addition, the analyzing module 15 can also manage color level ranges of all the first and second RGB values. As the color level range of the second RGB values is smaller than that of the first RGB values, and the number of differences in the color level range between the second RGB values and the corresponding first RGB values reach a range threshold value, the analyzing module 15 would determine that the instant state fulfills the abnormal condition.

It shall be explained that, according to the examination standard, since the present invention is mainly to utilize the color images to carry out analysis and display, thus colors for FIG. 5A, FIG. 5A, FIG. 9A and FIG. 9B are necessary. Namely, color plots can further demonstrate clearly the technical contents of the present invention.

When the alert module 17 receives the abnormal signal, an alert message would be generated for alerting and warning the user in a real-time manner that the servo motor drive system 2 may be in an abnormal state currently. In the present invention, the alert message can be a be sound, text, light or any other warning medium.

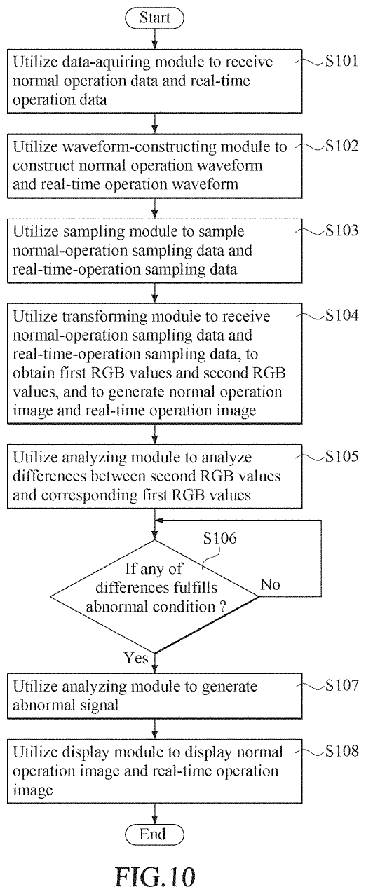

Finally, referring to FIG. 10, a schematic flowchart of a preferred embodiment of the method for analyzing image in accordance with the present invention is shown. The method for analyzing image, executed by utilizing the system for analyzing image 1 of FIG. 1, includes Step S101 to Step S108 as follows.

Step S101: Utilize the data-acquiring module to receive normal operation data and real-time operation data.

Step S102: Utilize the waveform-constructing module to construct a normal operation waveform and a real-time operation waveform.

Step S103: Utilize the sampling module to sample normal-operation sampling data and real-time-operation sampling data.

Step S104: Utilize the transforming module to receive the normal-operation sampling data and the real-time-operation sampling data, to obtain first RGB values and second RGB values through conversion, and to generate a normal operation image and a real-time operation image.

Step S105: Utilize the analyzing module to analyze differences between the second RGB values and the corresponding first RGB values.

Step S106: Determine whether or not one of the differences fulfills an abnormal condition.

If the determination is positive, then go to Step S107. If the determination is negative, then go back to Step S106 so as to determine whether or not the difference between the next second RGB value and the corresponding first RGB value fulfills the abnormal condition.

Step S107: Utilize the analyzing module to generate an abnormal signal.

Step S108: Utilize a display module to display the normal operation image and the real-time operation image.

Since contents of the method for analyzing image have already elucidated in previous sections, thus details thereabout would be omitted herein.

In summary, in the system and method for analyzing image provided by the present invention, the data-acquiring module, the waveform-constructing module, the sampling module, the transforming module and the analyzing module are included. In comparison to the prior art, the present invention can utilize the normal operation image and the real-time operation image to analyze in a real-time manner if any of the differences between the second RGB values and the corresponding first RGB values fulfills the abnormal condition, to further realize if the servo motor drive system is in the abnormal state, and thus to perform maintenance, repair and treatment in time to remove the abnormal state. In addition, the present invention can further utilize the display module to display the normal operation image and the real-time operation image, so that the instant state of the servo motor drive system can be determined immediately.

While the present invention has been particularly shown and described with reference to a preferred embodiment, it will be understood by those skilled in the art that various changes in form and detail may be without departing from the spirit and scope of the present invention.

What is claimed is:

1. A system for analyzing image, applied to a servo motor drive system, comprising:
a data-acquiring module, configured for receiving M normal operation data and M real-time operation data from the servo motor drive system;
a waveform-constructing module, configured for receiving the M normal operation data and the M real-time operation data, and further for constructing a normal operation waveform and a real-time operation waveform;
a sampling module, configured for evaluating the normal operation waveform and the real-time operation waveform to sample N normal-operation data sets and N real-time-operation data sets, each of the N normal-operation data sets including O normal-operation sampling data sampled from the M normal operation data, each of the N real-time-operation data sets including O real-time-operation sampling data sampled from the M real-time operation data, N<M, O<M;
a transforming module, configured for receiving N×O normal-operation sampling data and N×O real-time-operation sampling data, then for converting each of the N×O normal-operation sampling data into a first RGB value through a color conversion, further for converting each of the N×O real-time-operation sampling data into a second RGB value through the color conversion, and thereby for generating a normal operation image and a real-time operation image; and
an analyzing module, configured for utilizing the normal operation image to analyze the real-time operation image, and for generating an abnormal signal upon when a difference between the second RGB value and the corresponding first RGB value fulfills an abnormal condition;
wherein the color conversion is to multiply each of the normal-operation sampling data and each of the real-time-operation sampling data by 255, and then converts to form the first RGB value and the second RGB value.

2. The system for analyzing image of claim 1, wherein the abnormal condition is to indicate that the first RGB value of the normal operation image is not equal to the second RGB value of the corresponding real-time operation image.

3. The system for analyzing image of claim 2, wherein the abnormal condition is to indicate that the second RGB value of the real-time operation image is different to the first RGB value of the corresponding normal operation image.

4. The system for analyzing image of claim 1, wherein the data-acquiring module includes an analog-to-digital conversion unit configured for converting data formats of the N×O normal operation data and the N×O real-time operation data from analog formats into digital formats.

5. The system for analyzing image of claim 4, wherein the data-acquiring module further includes a normalization unit electrically connected with the analog-to-digital conversion unit and configured for performing data normalization upon the N×O normal operation data and the N×O real-time operation data.

6. The system for analyzing image of claim 4, wherein the data-acquiring module further includes a standardization unit electrically connected with the analog-to-digital conversion unit and configured for performing standardization upon the N×O normal operation data and the N×O real-time operation data.

7. The system for analyzing image of claim 1, wherein the sampling module includes a window-sampling unit configured for moving along the normal operation waveform and the real-time operation waveform so as to sample the N×O normal operation data and the N×O real-time operation data.

8. The system for analyzing image of claim 7, wherein the sampling module further includes a window-setting unit electrically connected with the window-sampling unit for setting a sampling width of the window.

9. The system for analyzing image of claim 1, further including a display module electrically connected with the transforming module and used for receiving and displaying the normal operation image and the real-time operation image.

10. The system for analyzing image of claim 1, further including an alert module electrically connected with the analyzing module and used for generating an alert message upon when the abnormal signal is received.

11. A method for analyzing image, applied to the system for analyzing image of claim 1, comprising the steps of:
(a) utilizing the data-acquiring module to receive the M normal operation data and the M real-time operation data;
(b) utilizing the waveform-constructing module to receive the M normal operation data and the M real-time operation data to further construct the normal operation waveform and the real-time operation waveform;
(c) utilizing the sampling module to evaluate the normal operation waveform and the real-time operation waveform to further sample the O normal-operation sampling data and the O real-time-operation sampling data;
(d) utilizing the transforming module to receive the O normal-operation sampling data and the O real-time-operation sampling data, to obtain the first RGB value and the second RGB value, through conversion, and to generate the normal operation image and the real-time operation image; and
(e) utilizing the analyzing module to generate the abnormal signal upon when the difference between the second RGB value and the corresponding first RGB value is determined to fulfill the abnormal condition.

12. The method for analyzing image of claim 11, further including a step (f) of utilizing a display module to display the normal operation image and the real-time operation image.
